(19) United States
(12) Patent Application Publication
(10) Pub. No.: US 2010/0289245 A1
(43) Pub. Date: Nov. 18, 2010

(54) Folding Bicycle

(76) Inventor: Ming-Ji Yang, Pingjhen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,448

(22) Filed: May 12, 2009

(51) Int. Cl. B62K 17/00

(52) U.S. Cl. 280/278

(57) ABSTRACT

A folding bicycle includes a front portion and a rear portion that are pivotally connected and positioned with each other by a buffer hinge assembly, which also helps to improve comfort of riding. The folding bicycle further has a buckle unit allowing a stem of the folding bicycle to be rotated, bent and positioned with respect to the rest of the front portion, and a long-lever brake assembly allowing easy braking operation and protecting brake wires from malicious cut. An adjustable supporter is provided on a frame of the front portion for carrying an external object, such as a secondary seat or a basket, while a housing made of punched metal parts and incorporating a luggage box is provided at the rear portion of the folding bicycle.

### BACKGROUND OF THE INVENTION

1. Technical Field

The present invention relates to bicycles, and more particularly, to a folding bicycle having a novel structure.

2. Description of Related Art

Please refer to FIG. 1 for a conventional folding bicycle 10, which comprises a front portion 90 and a rear portion 80 connected by a hinge 81 so that the front portion 90 and the rear portion 80 are allowed to pivot with respect to each other, causing the bicycle 10 foldable. Besides, a buckle 82 is provided to fasten and thus position the front portion 90 and the rear portion 80. A chair portion 83 is configured to be movable vertically with respected to the rear portion 80. In addition, the folding bicycle 10 has a stem 91 a that supports a handle bar 91 and is configured to be foldable at one direction. Thereby, the folding bicycle 10 is collapsible, thus facilitating storage and transportation.

However, in the aforementioned folding bicycle 10, since the portions and parts are not firmly combined, they tend to impact each other in riding. On the other hand, brake wires 95a are exposed externally and thus likely get damaged. Also, brake levers 95 of the folding bicycle 10 are configured short and thus ask for a great squeezing force to operate, which may endanger users in emergencies. Moreover, after collapsed, the folding bicycle 10 provides no dedicated grapping part for easy haul or push.

In view of these shortcomings of the prior art device, the inventor of the present invention, basing on his years of practical experience and professional knowledge in designing and manufacturing folding bicycles, has performed repeated experiments, and finally brings about a great improvement on existing folding bicycles.

### SUMMARY OF THE INVENTION

One objective of the present invention is to provide a folding bicycle, wherein a buffer hinge assembly is connected between a front portion and a rear portion of the folding bicycle so as to allow the front portion and the rear portion pivot with respect to each other and absorb shock of riding.

Another objective of the present invention is to provide a folding bicycle, wherein a buckle unit is connected between a stem and a front crown of the folding bicycle so as to allow the stem to be rotated, bent and positioned with respect to the other part of the front portion of the folding bicycle.

Another objective of the present invention is to provide a folding bicycle, wherein a long-lever brake assembly is provided so as to realize easy braking operation and protect brake wires from malicious cut.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a perspective view of a conventional folding bicycle;

FIG. 2 is a perspective view of a folding bicycle according to the present invention;

FIG. 3 is an enlarged drawing showing a long-lever brake assembly of the folding bicycle according to the present invention;

FIG. 4 and FIG. 5 illustrate a process whereon the folding bicycle is collapsed;

FIG. 6 is a schematic drawing showing a stem of the folding bicycle being revolved by a user; and

FIG. 7 is a schematic drawing of the folding bicycle wherein an adjustable supporter is depicted.

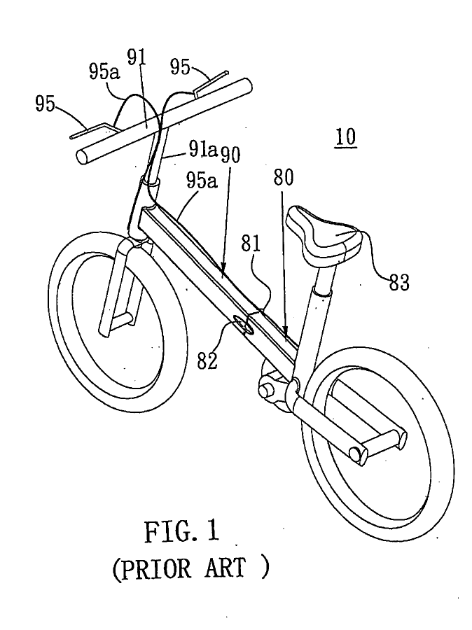

### DETAILED DESCRIPTION OF THE PREFERRED EMBODIMENTS

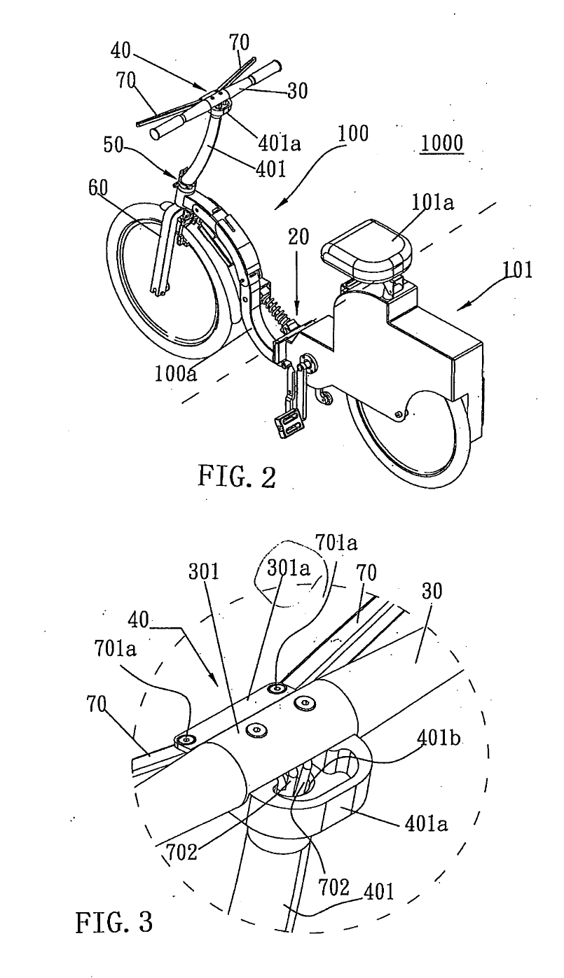

FIG. 2 is a perspective view of a folding bicycle 1000 according to the present invention. As shown in the drawing, the folding bicycle 1000 comprises a front portion 100 and a rear portion 101 that are pivotally coupled by means of a buffer hinge assembly 20. On the front portion 100, a long-lever brake assembly 40 is mounted on a handle bar 30 and a buckle unit 50 is deposited below a stem of the folding bicycle 1000.

FIG. 3 is an enlarged drawing showing the long-lever brake assembly 40 of the folding bicycle 1000. As can be seen in the drawing, the long-lever brake assembly 40 includes a positioning base 401a fixed to an upper end of the stem 401 and connected with the handle bar 30. The positioning base 401a has a through hole 401b communicated with an inner space of the stem 401. The positioning base 401a and the handle bar 30 are fastened together by a fastening member 301. A fin portion 301a overhanging a front side of the fastening member 301 provides two axial holes for each receiving one end of a brake lever 70 so that each said brake lever 70 is retained in the corresponding axial hole by a pivot pin 701a. Thereby, the two brake levers 70 are settled at a middle portion of the handle bar 30 (also referring to FIG. 2) and each have a maximum length extending from the middle portion of the handle bar 30 to either end of the handle bar 30. Thus, the long brake lever 70 provides an arm of force that is long enough for a user to easily squeeze for braking the running bicycle. Therein, the through hole 401b of the positioning base 401a allow brake wires of the brake levers 70 to enter the stem 401 and get coupled with front and rear brake mechanisms, respectively. In other words, the brake wires 702 are completely hidden and shielded from malicious cut.

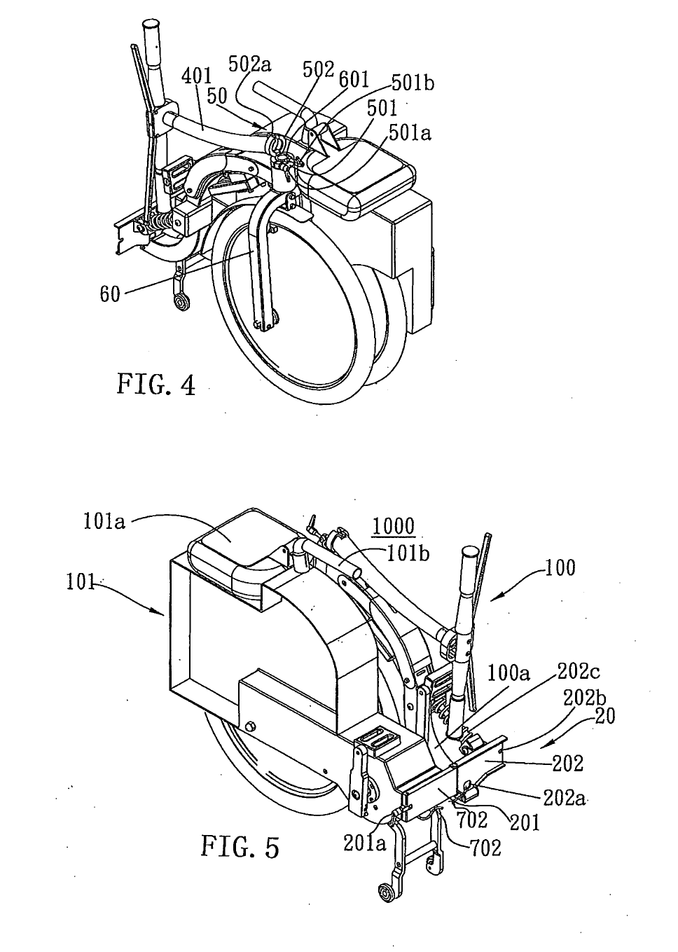

Please refer to FIGS. 2 and 4. The buckle unit 50 is deposited and thus allows relative bend as well as rotation between the stem 401 supporting the handle bar 30 and a fork crown 601 of a front fork 60. The buckle unit 50 comprises a C-shaped member 501 and a ring buckle 502. The C-shaped member 501 includes a fixer 501a and a bolt 501b. The ring buckle 502 has its one side coupled to the stem 401 and an opposite side pivotally connected with the C-shaped member 501. The ring buckle 502 includes a recess 502a for fittingly receiving the bolt 501b of the C-shaped member 501.

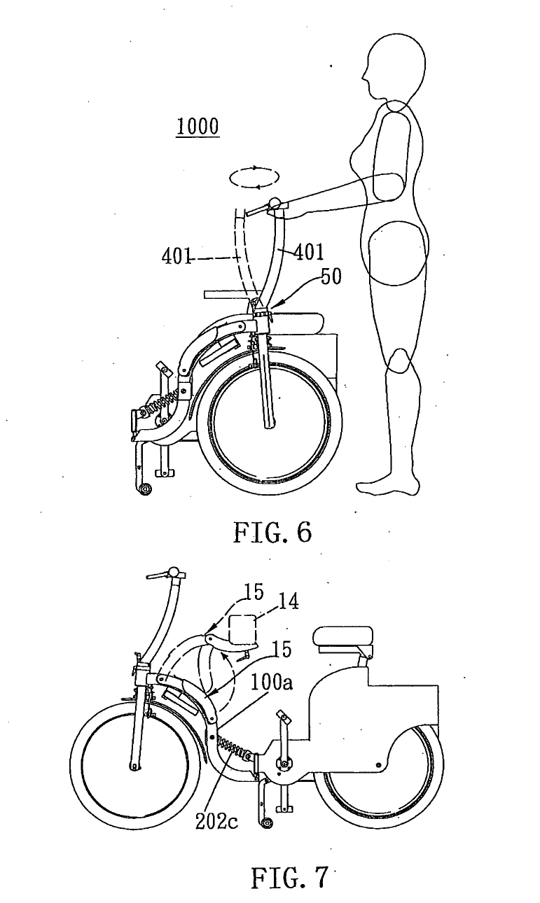

Referring to FIG. 4, by disengaging the bolt 501b from the recess 502a, the ring buckle 502 as well as the stem 401 coupled therewith is allowed to pivot with respect to the C-shaped member 501 as well as the fork crown 601 coupled therewith. To restore the bicycle 1000 to its service position, referring back to FIG. 2, the recess 502a of the ring buckle 502 and the bolt 501b of the C-shaped member 501 are coupled again so that the stem 401 is positioned on the fork crown 601 again. In addition, the fixer 501a of the C-shaped member 501 is operable to allow the C-shaped member 501, and the ring buckle 502 as well as the stem coupled therewith, to rotate against the fork crown 601 and to be positioned with respect to the fork crown 601 again. Thus, referring to FIG. 4 and 6, a use can adjust the position of the stem 401 relative to the rest part of the front portion 100 so as to facilitate haul or push on the folding bicycle 1000.

Referring to FIGS. 2 and 5 for the buffer hinge assembly 20 connected between the front portion 100 and the rear portion 101 of the folding bicycle 1000. The buffer hinge assembly 20 comprises a first hinge plate 201 and a second hinge plate 202. The first hinge plate 201 is fixed to the rear portion 101 and has a bolt 201a. The second hinge plate 202 is centrally formed with an opening 202a allowing the brake wires 702 to pass therethrough and has a fastening hole 202b formed near an edge thereof. Furthermore, the second hinge plate 202 has its lower edge pivotally connoted with a frame 100a of the front portion 100. A buffer 202c is connected between the second hinge plate 202 and the frame 100a, as can be seen clearly in FIGS. 2 and 7. Thus, when the front portion 100 and the rear portion 101 are drawn together, the hinge plates 201 and 202 are folded together. Then the bolt 201a of the first hinge plate 201 is coupled with the fastening hole 202b of the second hinge plate 202 so that the folding bicycle 1000 is ready for riding. In riding, the buffer 202c serves to absorb shock of riding and ensure a comfortable riding experience. As shown in the drawing, the rear portion 101 includes a housing made of punched metal parts. The rear portion 101 also comprises a luggage box and a pivotble seat 101a. The pivotble seat 101a has a gripping handle 101b provided at a bottom thereof so as to be gripped for easy haul or push of the collapsed folding bicycle 1000.

Referring to FIG. 7, an adjustable supporter 15 is configured to be able to retract or expand with respect to the frame 100a of the front portion. The adjustable supporter 15 is composed of three pivotally connected arms, wherein one of the arms is pivotally connected to another of the arms that is detachably inserted to the frame 100a so that the two arms jointly support the other arm that further carries an external object 14, such as a secondary seat or a basket, in the manner that the altitude of the external object is adjustable.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A folding bicycle, comprising a front portion and a rear portion pivotally connected by a buffer hinge assembly, wherein the front portion has a long-lever brake assembly provided at a handle bar of the front portion and a buckle unit deposited below a stem of the front portion, the folding bicycle being characterized in:
the long-lever brake assembly including:
a positioning base, fixed to an upper end of the stem and having a through hole communicated with an inner space of the stem; and
a fastening member, located at a middle portion of the handle bar for fastening the positioning base and the handle bar together;
wherein the fastening member including a fin portion overhanging a front side of the fastening member, and the fin portion provides two axial holes for each receiving one end of a brake lever so that each said brake lever is retained in the corresponding axial hole by a pivot pin;
thereby, the two brake levers being settled near the middle portion of the handle bar and each having a maximum length extending from the middle portion of the handle bar to either end of the handle bar so that the brake lever provides an arm of force that is long enough for a user to easily squeeze for braking; and
therein, the through hole of the positioning base allowing brake wires of the brake levers to enter the stem and get coupled with front and rear brake mechanisms, respectively, so as to cause the brake wires completely hidden and shielded from malicious cut.

2. A folding bicycle, comprising a front-portion and a rear portion pivotally connected by a buffer hinge assembly, wherein the front portion has a long-lever brake assembly provided at a handle bar of the front portion and a buckle unit deposited below a stem of the front portion, the folding bicycle being characterized in:
the buckle unit deposited between the stem supporting the handle bar and a fork crown of a front fork, and including:
a C-shaped member, having a fixer and a bolt; and
a ring buckle, fixed to the stem and having a recess for fittingly receiving the bolt of the C-shaped member;
thereby, when the bolt is disengaged from the recess, the ring buckle as well as the stem fixedly coupled therewith being allowed to pivot with respect to the C-shaped member as well as the fork crown coupled therewith, and when the recess of the ring buckle and the bolt of the C-shaped member are coupled again, the stem being positioned on the fork crown again; and
therein, the fixer of the C-shaped member being operable to allow the C-shaped member, and the ring buckle as well as the stem coupled therewith, to rotate against the fork crown and to be positioned with respect to the fork crown again.

3. A folding bicycle, comprising a front portion and a rear portion pivotally connected by a buffer hinge assembly, wherein the front portion has a long-lever brake assembly provided at a handle bar of the front portion and a buckle unit deposited below a stem of the front portion, the folding bicycle being characterized in:
the buffer hinge assembly, connected between the front portion and the rear portion of the folding bicycle, and including:
a first hinge plate, fixed to the rear portion and having a bolt;
a second hinge plate, centrally formed with an opening allowing the brake wires to pass therethrough, and having a fastening hole formed near an edge thereof, wherein the second hinge plate has a lower edge thereof pivotally connoted with a frame of the front portion; and
a buffer, connected between the second hinge plate and the frame of the front portion for absorbing shock of riding;
thereby, when the hinge plates and are drawn together, the front portion and the rear portion being posed into a service position, and the bolt of the first hinge plate being allowed to couple with the fastening hole of the second hinge plate so that the folding bicycle is ready for riding.
